(19) United States
(12) Patent Application Publication
(10) Pub. No.: US 2008/0052989 A1
(43) Pub. Date: Mar. 6, 2008

(54) Floral Wrapper with Decorative Portion and Method

(76) Inventor: Donald E. Weder, Highland, IL (US)

Correspondence Address: DUNLAP CODDING & ROGERS, P.C., PO BOX 16370, OKLAHOMA CITY, OK, 73113, US

(21) Appl. No.: 11/929,109

(22) Filed: Oct. 30, 2007

Related U.S. Application Data
(63) Continuation of application No. 11/217,861, filed on Sep. 1, 2005.
Application No. 11/217,861 is a continuation-in-part of application No. 11/082,172, filed on Mar. 16, 2005, now abandoned.
Application No. 11/082,172 is a continuation of application No. 10/619,062, filed on Jul. 10, 2003, now abandoned.
Application No. 10/619,062 is a continuation-in-part of application No. 10/446,500, filed on May 27, 2003, now abandoned.
(63) Continuation-in-part of application No. 10/666,576, filed on Sep. 17, 2003, now Pat. No. 6,962,021.
Application No. 10/666,576 is a continuation of application No. 10/195,595, filed on Jul. 12, 2002, now Pat. No. 6,647,663.
Application No. 10/195,595 is a continuation-in-part of application No. 09/956,833, filed on Sep. 20, 2001, now Pat. No. 6,438,898.
Application No. 09/956,833 is a continuation-in-part of application No. 09/327,721, filed on Jun. 8, 1999, now Pat. No. 6,295,760.

(51) Int. Cl. A01G 9/02

(52) U.S. Cl. 47/72

(57) ABSTRACT

A wrapper for wrapping a flower pot and/or floral grouping or other item. The wrapper is constructed of a sheet of material or sleeve having at least one bend which separates the sheet or sleeve into at least two portions having different decorative effects. When the wrapper is formed about a flower pot or other item to form a decorative cover, the variation in the decorative effects of the wrapper provides the cover with at least a “two-sheet” effect which provides the decorative cover with the appearance of being constructed of at least two or more separate sheets. The wrapper may also comprise a decorative extension or detachable portion and may comprise a ribbon or preformed pot cover.

### CROSS REFERENCE TO RELATED APPLICATIONS

The present application is a continuation of co-pending U.S. Ser. No. 11/217,861, filed on Sep. 1, 2005; which is a continuation-in-part of U.S. Ser. No. 11/082,172, filed Mar. 16, 2005, which is a continuation of U.S. Ser. No. 10/619,062, filed Jul. 10, 2003, now abandoned, which is a continuation-in-part of U.S. Ser. No. 10/446,500, filed May 27, 2003, now abandoned. The present application is also a continuation-in-part of U.S. Ser. No. 10/666,576, filed Sep. 17, 2003; which is a continuation of U.S. Ser. No. 10/195,595, filed Jul. 12, 2002, now U.S. Pat. No. 6,647,663; which is a continuation-in-part of U.S. Ser. No. 09/956,833, filed Sep. 20, 2001, now U.S. Pat. No. 6,438,898, which is a continuation-in-part of U.S. Ser. No. 09/327,721, filed Jun. 8, 1999, now U.S. Pat. No. 6,295,760. The specifications of the above-reference applications are hereby expressly incorporated by reference herein in their entirety.

### BACKGROUND

This invention generally relates to but is not limited to, wrappers used to wrap items, including floral groupings and/or media, or flower pots containing floral groupings and/or media, and methods of using same.

### DESCRIPTION OF THE DRAWINGS

FIG. 1 is a perspective view of a wrapper of the present invention.

FIG. 2 is a cross-sectional view of the wrapper of FIG. 1.

FIG. 3 is a perspective view of an alternate embodiment of the wrapper of the present invention.

FIG. 4 is a cross-sectional view of the alternate embodiment of FIG. 3.

FIG. 5 is a perspective view of the wrapper of FIG. 1 formed about a potted plant.

FIG. 6 is a perspective view of an alternate embodiment of the wrapper of the present invention.

FIG. 7 is a cross-sectional view of an alternate embodiment of the wrapper of FIG. 6.

FIG. 8 is a perspective view of the wrapper of FIG. 6 formed about a potted plant.

FIG. 9 is a perspective view of an alternate embodiment of the wrapper of the present invention.

FIG. 10 is a cross-sectional view of the embodiment of FIG. 9.

FIG. 11 is a perspective view of the wrapper of FIG. 9 formed about a potted plant.

FIG. 12 is a perspective view of an alternate embodiment of the wrapper of the present invention.

FIG. 13 is a cross-sectional view of the embodiment of FIG. 12.

FIG. 14 is a perspective view of the wrapper of FIG. 12 formed about a potted plant.

FIG. 15 is a perspective view of an alternate embodiment of the wrapper of the present invention.

FIG. 16 is a cross-sectional view of the embodiment of FIG. 15.

FIG. 17 is a perspective view of the wrapper of FIG. 15 formed about a potted plant.

FIG. 17 is a perspective view of an alternate embodiment of the wrapper of the present invention.

FIG. 18 is a cross-sectional view of the embodiment of FIG. 17.

FIG. 19 is a perspective view of another embodiment of the wrapper of the present invention.

FIG. 20 is a perspective view of the embodiment of FIG. 19 having a potted plant disposed thereon in preparation for wrapping.

FIG. 21 is a perspective view of the wrapper of FIG. 19 formed about a potted plant.

FIG. 22 is an elevational view of another embodiment of the wrapper of the present invention.

FIG. 23 is a cross-sectional view of the embodiment of FIG. 22.

FIG. 24 is a perspective view of the wrapper of FIG. 22 formed about a floral grouping.

FIG. 25 is a perspective view of the wrapper of FIG. 22 formed about a potted plant.

FIG. 26 is a perspective view of another embodiment of the wrapper of the present invention.

FIG. 27 is a cross-sectional view of the embodiment of FIG. 26.

FIG. 28 is a perspective view of the wrapper of FIG. 26 formed about a floral grouping.

FIG. 29 is a perspective view of the wrapper of FIG. 26 formed about a potted plant.

FIG. 30 is an elevational view of another embodiment of the wrapper of the present invention.

FIG. 31 is a cross-sectional view of the embodiment of FIG. 30.

FIG. 32 is a cross-sectional view of an embodiment of the present invention having an open lower end.

FIG. 33 is a perspective view of the wrapper of FIG. 32 formed about a potted plant.

FIG. 34 is a cross-sectional view of another embodiment of the present invention having an open lower end.

FIG. 35 is an elevational view of a ribbon constructed in accordance with the present invention.

FIG. 36 is a cross-sectional view of the ribbon of FIG. 35.

FIG. 37 is a perspective view of the ribbon of FIG. 35 formed about a wrapper disposed about a pot.

FIG. 38 is a perspective view of a box wrapped with a ribbon of material of FIG. 35.

FIG. 39 is a preformed pot cover constructed in accordance with the present invention.

FIG. 40 is a cross-sectional view of the preformed pot cover of FIG. 39.

FIG. 41 is an elevational view of an alternate embodiment of the wrapper of the present invention.

FIG. 42 is a cross-sectional view of the wrapper of FIG. 41.

FIG. 43 is a perspective view of the wrapper of FIG. 41 formed about a potted plant.

### DETAILED DESCRIPTION OF THE INVENTION

The present invention is a sheet of material (also referred to herein as a “wrapper” or “decorative wrapper”) for decorating and covering flower pots, flower pots having floral groupings (plants) therein, floral groupings comprising cut flowers, corsages, floral groupings disposed in a “non-pot” floral holding material such as a foam or fiber block, and non-pot or non-plant including, but not limited to, items such as baskets, gifts, gift boxes, fruit or candy boxes, and other boxed or unboxed items including nuts, vegetables, plant bulbs, and comestibles. The wrappers contemplated herein could be used as a basket or box liner or as a decorative filler for a bag, gift bag, or box, rather than as a wrapper. The wrappers described herein could be used as a filler for a box or item to be shipped. Preferably, the wrapper contemplated herein comprises a single sheet of material having at least a first decorative portion and a second decorative portion and a bend (or fold) therebetween. The wrapper described herein may be used also to produce a preformed pot cover, such as a Speed Cover™ formed for example by a mated mold system such as described in U.S. Pat. No. 4,773,182, which is hereby expressly incorporated by reference herein in its entirety.

In the present invention, when the sheet of material or wrapper is disposed about a potted plant or other item, the decorative cover formed thereby has a layered appearance of being comprised of two (or more) separate and different decorative sheets of material. Previously, in order to achieve this “two-sheet” appearance or effect, the user had to use two entire sheets of material, which were either separate or attached. If the sheets of material were separate, the user was required to obtain a first sheet of material then place a second sheet of material upon the first sheet of material then shift and move the second or first sheet about so as to achieve close or symmetric alignment of the edges of the sheets so as to provide a consistent and pleasing decorative effect of the two sheet cover when the combined two sheets of material were wrapped about a flower pot or other item. The process was even more difficult and time consuming when three or more sheets were used for obtaining a “three-sheet” (or more) appearance or layered effect. Further, the process of manually aligning separate sheets of material upon each other can be difficult due to the “dinginess” of polymer films.

The wrapper of the present invention therefore enables the user to obtain the same “two-sheet” appearance or layered effect as obtained with two entirely separate or different sheets of material but without the extra effort and difficulties of having to manually align the two sheets and, moreover, without the higher expense required by using two separate entire sheets. Users of the present invention not only benefit from increased ease and consistency of application, but also enjoy considerable cost savings due to the significantly reduced labor and material costs obtained by employing single sheets.

These embodiments and others of the present invention are now described in more detail below. It will be appreciated that the examples provided herein are not intended to limit the scope and extent of the claimed invention but are only intended to exemplify various embodiments of the invention contemplated herein.

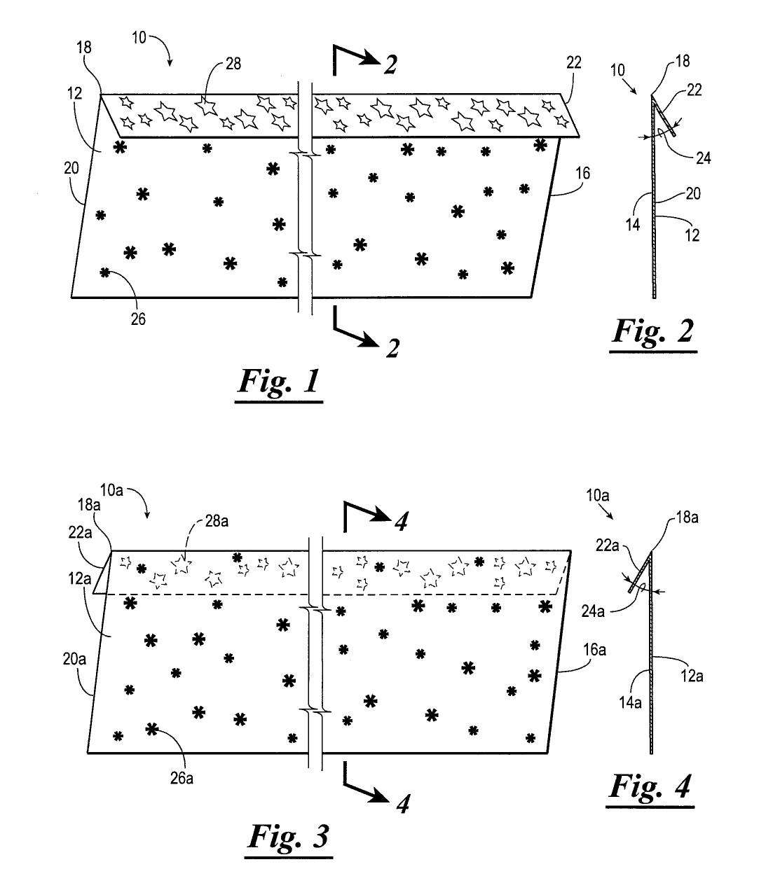

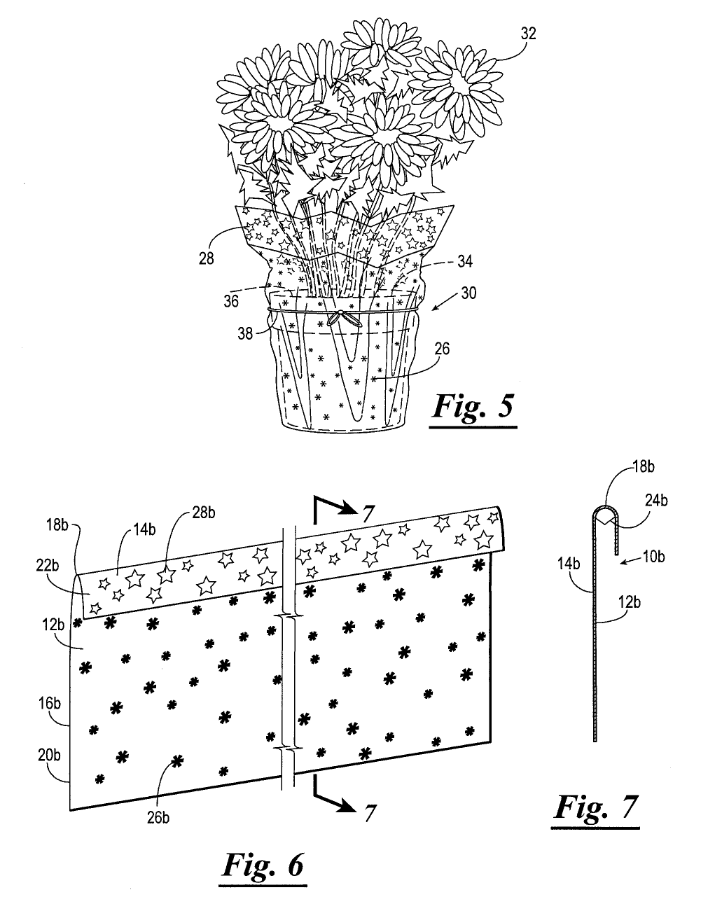

Shown in FIGS. 1 and 2 and designated therein by reference numeral 10 is a sheet of material having a first surface 12, a second surface 14 and an outer peripheral edge 16. The sheet of material 10 has a bend 18 therein which forms an angular change in the sheet of material 10 extending across at least a portion of the sheet of material 10. The bend 18 substantially separates the sheet of material 10 into a first portion 20 and a second portion 22 wherein the bend 18 forms an angle 24 between the first portion 20 and the second portion 22. The first portion 20 has a first decorative feature 26 upon at least a portion thereof, and the second portion 22 has a second decorative feature 28 upon at least a portion thereof. When the sheet of material 10 is formed about an item such as a potted plant 32, the sheet of material 10 is formed into a decorative cover 30 which extends about at least a portion of the potted plant 32 such as shown in FIG. 5. The potted plant 32 comprises a pot 34 having an upper rim 36.

The sheet of material 10 forming the decorative cover 30 may be secured about the pot 34, or potted plant 30, or a floral grouping or other item contemplated herein via a securing element 38 defined herein as including, but not limited to, devices such as a rubber band, elastic band, non-elastic band, string, ribbon, wire or plastic tie, shrink films or materials (e.g., heat shrink, chemical shrink, or moisture-shrink film), collar, sleeve, tape, label, stribbon, stretch film, metal strip, overpot, jardiniere overpot, Speed Cover™, or any other banding device known to those of ordinary skill in the art. The securing element 38, when used, may be positioned below or above the upper rim 36 of the potted plant 32 or other item wrapped within the decorative cover 30. More than one securing element 38 can be used. The securing element 38 may be applied manually or automatically. The securing element 38 preferably is a banding element or other device described herein but may also be an adhesive or cohesive material, barbs or slots on the pot 34, pins, clips, springs, staples, magnets, heat seals, chemical seals, vibratory seals or any other binding or securing materials known in the art. The securing element 38 can be attached to the sheet of material 10 and/or extension thereof, or initially can be separate from the sheet of material 10 or extension thereof.

The first decorative feature 26 of the first portion 20, and the second decorative feature 28 of the second portion 22 each comprise a color, decoration, design, texture, pattern, embossment, appearance or characteristic of the material from which the sheet of material 10 is constructed. The first decorative feature 26 and second decorative feature 28 are different in same aspect such that when the sheet of material 10 is formed about the item, the decorative cover 30 formed therefrom has an appearance of being made from at least two separate sheets of material.

The outer peripheral edge 16 may be straight or curved (non-linear). Or, portions of the outer peripheral edge 16 may be straight and other portions may be curved (non-linear).

The sheet of material 10 can be constructed, in whole or in part, from materials including, but not limited to, polymer films, metallized polymer films, natural films, metallized natural films, printed materials of any type, matted materials of any type, cloth, fabric, spunbonded or melt blown materials, cling or “cling-type” materials, paper, tissue, cellophane, biodegradable materials, recyclable materials, and deadfold materials including metal foils and polyfoil. The materials may have a “cloth-like” or “paper-like” appearance. The materials may be embossed. The material may be waterproof. The sheet of material 10 may have different colors, patterns, or textures. In one embodiment, the sheet of material 10 may be constructed of a polymer film which has been printed to have the appearance of a spun-bonded or melt-blown material. Other materials and methods of providing a material with a decorative appearance will readily come to the mind of the person of ordinary skill in the art.

The materials from which the sheet of material 10 is constructed preferably have a thickness in a range from about 0.1 mil to about 30 mils. Often, the thicknesses of the materials are in a range from about 0.5 mil to about 10 mils or preferably, in a range from about 1.0 mil to about 5 mils. Preferably, the materials are flexible, semi-rigid, rigid, or any combination thereof. The material may be constructed of a single layer of material or a plurality of layers of the same or different types of materials. Any thickness of the material may be utilized as long as the material functions in accordance with the present invention as described herein. Any thickness of material may be utilized in accordance with the present invention as long as the sheet of material 10 may be formed as described herein, and as long as the decorative cover 30 may contain at least a portion of a flower pot, potted plant, growing medium or floral grouping or other item, as described herein.

As noted above, the sheet of material 10 shown or described herein may be constructed from any suitable material that is capable of being formed into a decorative cover 30 as contemplated herein and wrapped about a flower pot and/or a floral grouping or other item disposed therein. Preferably, the materials include treated or untreated paper, metal foil including deadfold materials, polymeric film, non-polymeric film woven, or nonwoven fabric, or synthetic or natural fabric, cardboard, fiber, cloth, burlap, or laminations or combinations thereof. Preferably, the material used to construct the sheet of material 10 is a waterproof material such as BOPP (biaxially oriented polypropylene) or metallized BOPP, or is substantially waterproof or water resistant.

The term “polymeric film” when used herein means a film made of a synthetic polymer such as a polypropylene or a naturally occurring polymer such as cellophane. A polymeric film is relatively strong and not as subject to tearing (substantially non-tearable), as might be the case with paper or foil.

The materials used to construct the sheet of material 10 may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination in the material. Moreover, portions of the materials used in constructing the sheets of material 10 shown or described herein may vary in the combination of such characteristics. The materials utilized in the sheets of material 10 may be opaque, translucent, transparent, or partially clear or tinted transparent. The wrapper may have a low-slip (non-slip) material thereon which imparts a “frictional” quality to the wrapper. The non-slip coating may have a high coefficient of friction and may be disposed on either surface of the wrapper. The coating may be a lacquer. The low- or non-slip material preferably reduces the tendency of the decorative cover 30 to slip or slide off the pot 34 or the securing element 38 to slide or slip upwardly or downwardly.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping preferably comprises a bloom or foliage portion and a stem portion and may comprise roots. Further, the floral grouping may be the plant portion of the potted plant 32. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule”.

The term “growing medium” or “retaining medium” when used herein means any liquid, solid or gaseous material used for plant growth or for the cultivation of propagules, including organic and inorganic materials such as soil, humus, perlite, vermiculite, sand, water, foam, and including the nutrients, fertilizers or hormones or combinations thereof required by the plants or propagules for growth or any material effective in supporting a plant, cutting, or floral grouping.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet of floral grouping. The term “propagule” when used herein means any structure capable of being propagated or acting as an agent of reproduction including seeds, shoots, stems, runners, tubers, plants, leaves, roots, or spores.

In accordance with the present invention, a bonding material may optionally be disposed on a portion of any of the sheet of material 10 shown or described herein to attach each decorative cover 30 to a pot 34 or other item or to assist in closing or sealing an upper portion of the decorative cover 30, respectively, or in adhering the decorative cover 30 to the pot 34 or other item.

As noted elsewhere herein, the sheet of material 10 contemplated herein may comprise one or more portion which are detachable via a detaching element. The term “detaching element” where used herein means any element or device such as, but not limited to, perforations, tear strips, zippers, and any other devices or elements of this nature known in the art, or any combination thereof, which enable the tearing away or detachment of one object from another.

The term “flower pot” or “pot” as used herein refers to any type of container used for holding a floral grouping or plant, including vases. Examples of pots, used in accordance with the present invention include, but are not limited to, clay pots, foam pots, wooden pots, plastic pots, pots made from natural and/or synthetic fibers (such as peat moss), and/or any combination thereof. The flower pot is adapted to receive a floral grouping in the retaining space thereof. The floral grouping may be disposed within the flower pot along with a suitable growing medium described elsewhere herein, or other retaining medium, such as a floral foam.

Preferably the decorative covers 30 shown or described herein are sized to contain and conform to at least one of a variety of standard sizes of pots 34 known to those of ordinary skill in the art, such as 3½ inch, 4 inch, 4½ inch, 5 inch, 5½ inch, 6 inch, 6½ inch, 7 inch, 7½ inch, 8 inch and 8½ inch pots or pots that are larger than, smaller than, or intermediate between such pot sizes such that preferably when the decorative cover 30 is applied about the pot, a skirt portion is formed as described earlier which is positioned near the upper rim 30 of the pot 34.

It will be understood however by one of ordinary skill in the art that the sheets of material 10 described herein may comprise any other pattern thereon, or may not have a pattern, but may only be differently textured or colored. For example, the first portion 20 may be opaque and have a color, decoration, or texture (or all of these, for example) while the second portion 22 is decorated yet is transparent. Any image disposed on the sheet of material 10 or any portion thereof or any other may be die cut or printed thereon or die cut or printed in register thereon.

The sheets of material 10 described herein may be supplied in a stack of individual sheets, in a pad wherein the sheets are attached together, or in a roll, wherein individual sheets are separated from the roll via perforations preplaced into the webbing of the roll, or by separation via a cutting or shearing implement, or in a pad of separate sheets which is rolled about a stiff cylinder (such as cardboard) for easy removal. Any of the sheets described herein may have a hole, slot, or perforations, therein (not shown) for insertion of the stem or stems of a floral grouping for enabling the sheet to be wrapped about a floral grouping without a pot. The hole, slot, or perforations may be located in any portion of the sheet of material but preferably are located in a centrally disposed portion thereof or may be offset from the center.

Although the outer peripheral edge 16 of the sheet of material 10 shown herein generally have a straight or curved (non-linear) pattern, it will be understood that the outer peripheral edge 16 may have any non-linear pattern, such as a geometric pattern, for example, sine wave, arced, toothed, angular, crenelate, crenate, crenulate, scalloped, starred, or may have a combination of a linear and non-linear pattern or an irregular pattern. The outer peripheral edge and/or peripheral decorations described herein may have a biomorphic shape such as a face, animal, flower, rabbit, Santa Claus, egg, or other image printed thereon or present as a shape within the edges.

In one embodiment, the present invention contemplates a method of providing a decorative cover for an item such as a potted plant, floral grouping, or other item described or contemplated herein wherein the method comprises providing one or more of any of the sheets of material described herein, and selling and delivering the sheet of material to a producer or seller of items for producing a decoratively covered item by the producer or seller, wherein the decoratively covered item is capable of being produced by wrapping a single (or more than one) wrapper about the item and securing the single (or more than one) wrapper in place about the item via a securing element as described elsewhere herein (or by simply forming the wrapper about the item if the wrapper is formed from a deadfold material wherein the wrapper is not necessarily secured about the item by a separate securing element) thereby providing the decorative cover about the item and wherein the decoratively covered item able to be so produced has an appearance of an item wrapped by at least two separate sheets of material (a “two-sheet effect”).

The sheet of material 10 of any of the decorative covers described herein may be constructed to have any effective or decorative shape, such as a square, a rectangle, a polygon, a circle, an oval, a triangle, star, or other shape as long as the decorative cover has a first portion and a second portion. For example the sheet of material may have a sine wave, scalloped, toothed, or other shape comprising its border.

Further, as noted above, the decorative effect may comprise biomorphic shapes such as “bunny rabbit” shapes, or “leaf” type shapes therein. These represent but two examples of biomorphic shapes which the decoration of the decorative covers 30 described herein may comprise.

When the sheet of material 10 is constructed from a material having “dead-fold” properties, e.g., a metal foil, wherein the sheet of material 10 readily holds its shape when folded or wrapped, it may not be necessary to secure the decorative cover 30 about a pot 34 or item with the securing element 38.

Shown in FIGS. 3 and 4 and designated therein by reference numeral 10a is another embodiment of the present invention comprising a sheet of material essentially similar to sheet of material 10 as described elsewhere herein and having a first surface 12a, a second surface 14a, and an outer peripheral edge 16a.

Sheet of material 10a has a bend 18a which forms an angular change in the sheet of material 10a extending across at least a portion of the sheet of material 10a. The bend 18a substantially separates the sheet of material 10a into a first portion 20a and a second portion 22a wherein the bend 18a forms an angle 24a between the first portion 20a and the second portion 22a. The first portion 20a has a first decorative feature 26a upon at least a portion thereof and the second portion 22a has a second decorative feature 28a upon at least a portion thereof. The first decorative feature 26a is preferably different from the second decorative feature 28a, in a manner similar to that of sheet of material 10. Preferably at least a portion of second portion 22a overlaps with at least a portion of first portion 20a. Said overlapping portion may be connected or attached to the adjacent portion of the sheet of material 10a via a connecting material or means such as an adhesive or cohesive bonding material. When the sheet of material 10a is formed about an item such as a potted plant, the sheet of material 10a is formed into a decorative cover (not shown, but similar to the decorative cover 30 of FIG. 5) which extends about at least a portion of the item and which has an appearance of being made from at least two separate sheets of material. Sheet of material 10a differs from sheet of material 10 primarily in that the bend 18a is reversed.

Shown in FIGS. 6 and 7 and designated therein by reference numeral 10b is another embodiment of the present invention comprising a sheet of material essentially similar to sheet of material 10 as described elsewhere herein and having a first surface 12b, a second surface 14b, and an outer peripheral edge 16b.

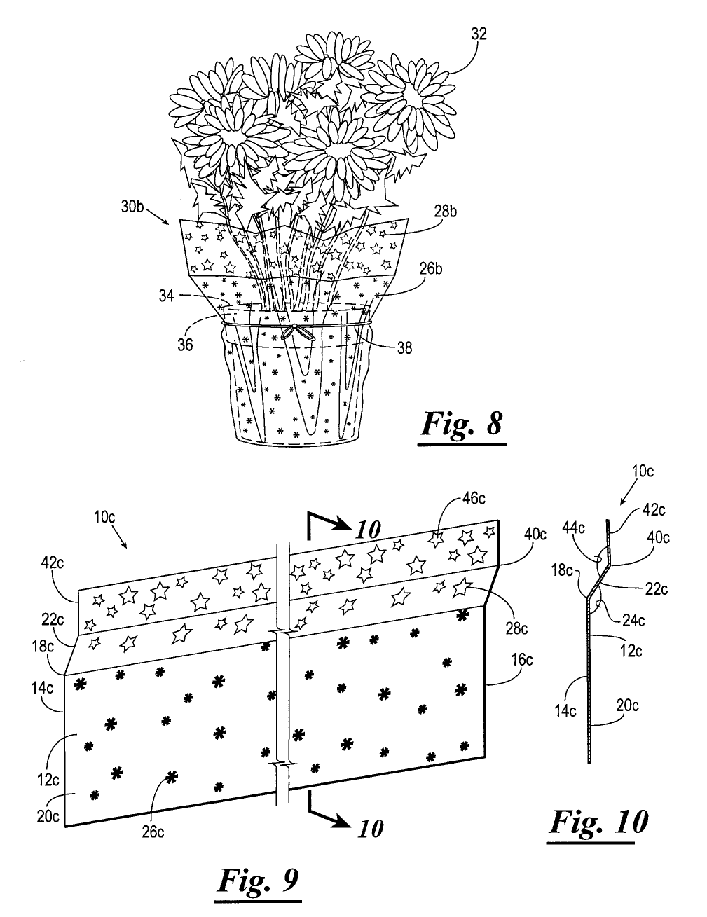

Sheet of material 10b has a curved bend 18b which forms an angular change in the sheet of material 10b extending across at least a portion of the sheet of material 10b. The curved bend 18b substantially separates the sheet of material 10b into a first portion 20b and a second portion 22b wherein the curved bend 18b forms a curved angle 24b between the first portion 20b and the second portion 22b. The first portion 20b has a first decorative feature 26b upon at least a portion thereof and the second portion 22b has a second decorative feature 28b upon at least a portion thereof. The first decorative feature 26b is preferably different from the second decorative feature 28b, in a manner similar to that of sheet of material 10. Preferably at least a portion of second portion 22b overlaps with at least a portion of first portion 20b. Said overlapping portion may be connected or attached to the adjacent portion of the sheet of material 10b via a connecting material or means such as an adhesive or cohesive bonding material. When the sheet of material 10b is formed about an item such as a potted plant 32, the sheet of material 10b is formed into a decorative cover 30b of FIG. 8 which extends about at least a portion of the potted plant 32 and which has an appearance of being made from at least two separate sheets of material. Sheet of material 10b differs from sheet of material 10 primarily in that the curved bend 18b is more curved than angular.

Shown in FIGS. 9 and 10 and designated therein by reference numeral 10c is another embodiment of the present invention comprising a sheet of material essentially similar to sheet of material 10 except as described below and having a first surface 12c, a second surface 14c, and an outer peripheral edge 16c.

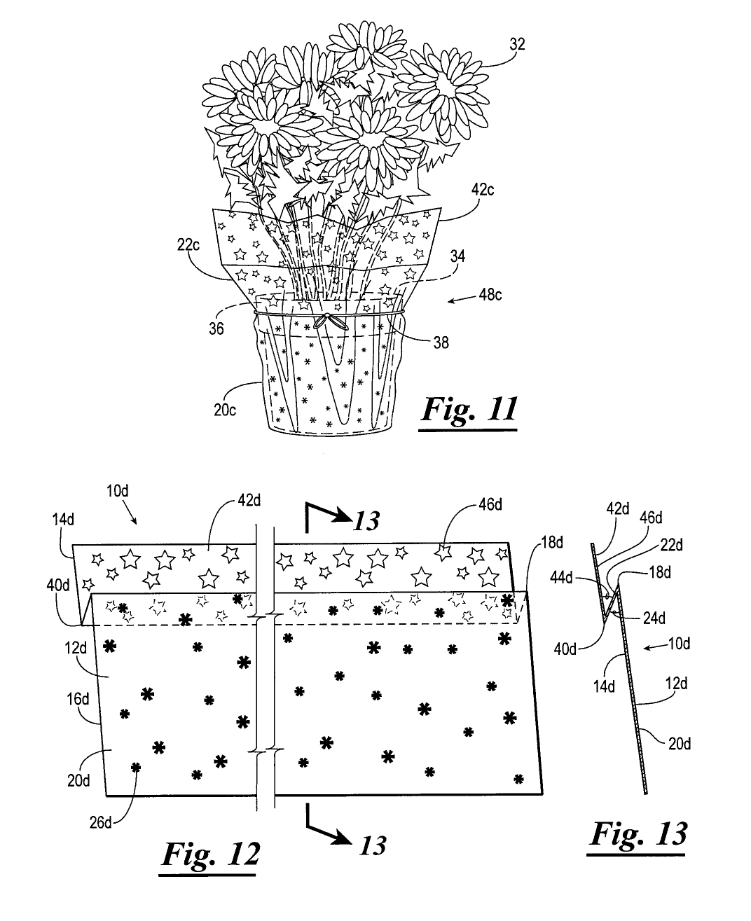

Sheet of material 10c has a first bend 18c and a second bend 40c each of which forms an angular change in the sheet of material 10c extending across at least a portion of the sheet of material 10c. The first bend 18c substantially separates the sheet of material 10c into a first portion 20c and a second portion 22c wherein the first bend 18c forms a first angle 24c between the first portion 20c and the second portion 22c. The first portion 20c has a first decorative feature 26c upon at least a portion thereof and the second portion 22c has a second decorative feature 28c upon at least a portion thereof. The second bend 40c substantially further separates the sheet of material 10c into a third portion 42c wherein the second bend 40c forms a second angle 44c between the second portion 22c and the third portion 42c. The third portion 42c has a third decorative feature 46c which is different from at least one of the first decorative feature 26c and the second decorative feature 28c. Preferably each of first angle 24c and second angle 40c is greater than 90 degrees, but one may be greater than 90 degrees and the other less than 90 degrees. When the sheet of material 10c is formed about an item such as a potted plant 32, the sheet of material 10c is formed into a decorative cover 48c (FIG. 11) which extends about at least a portion of the item, the decorative cover 48c is preferably secured thereabout by a securing element 38, and has an appearance of being made from at least two separate sheets of material.

Shown in FIGS. 12 and 13 and designated therein by reference numeral 10d is another embodiment of the present invention comprising a sheet of material essentially similar to sheet of material 10 except as described below and having a first surface 12d, a second surface 14d, and an outer peripheral edge 16d.

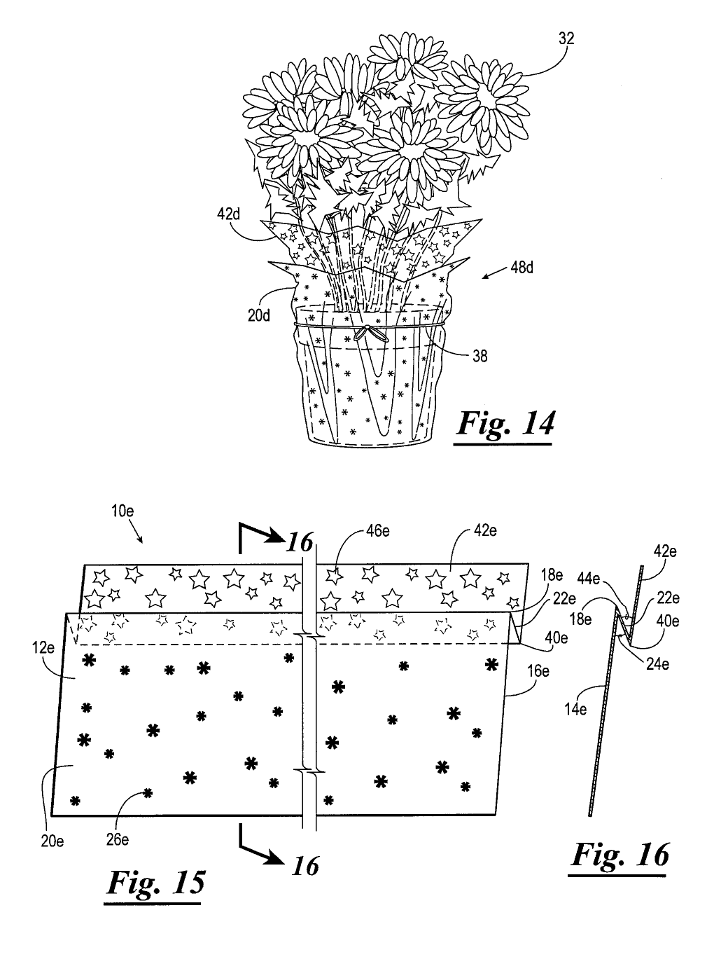

Sheet of material 10d has a first bend 18d and a second bend 40d each of which forms an angular change in the sheet of material 10d extending across at least a portion of the sheet of material 10d. The first bend 18d substantially separates the sheet of material 10d into a first portion 20d and a second portion 22d wherein the first bend 18d forms a first angle 24d between the first portion 20d and the second portion 22d. The first portion 20d has a first decorative feature 26d upon at least a portion thereof and the second portion 22d has a second decorative feature (not shown) upon at least a portion thereof. The second bend 40d substantially further separates the sheet of material 10d into a third portion 42d wherein the second bend 40d forms a second angle 44d between the second portion 22d and the third portion 42d. The third portion 42d has a third decorative feature 46d which is different from at least one of the first decorative feature 26d and the second decorative feature. Preferably each of first angle 24d and second angle 40d is less than or equal to 90 degrees, but one may be greater than 90 degrees and the other less than or equal to 90 degrees. Preferably at least a portion of second portion 22d overlaps with at least a portion of first portion 20d and/or third portion 42d. Any of said overlapping portions may be connected or attached to an adjacent portion of the sheet of material 10d via a connecting material or means such as an adhesive or cohesive bonding material. When the sheet of material 10d is formed about an item such as a potted plant 32, the sheet of material 10d is formed into a decorative cover 48d (FIG. 14) which extends about at least a portion of the item, the decorative cover 48d is preferably (optionally) secured thereabout by a securing element 38, and has an appearance of being made from at least two separate sheets of material.

Shown in FIGS. 15-16 and designated therein by reference numeral 10e is another embodiment of the present invention comprising a sheet of material essentially similar to sheet of material 10 except as described below and having a first surface 12e, a second surface 14e, and an outer peripheral edge 16e.

Sheet of material 10e has a first bend 18e and a second bend 40e each of which forms an angular change in the sheet of material 10e extending across at least a portion of the sheet of material 10e. The first bend 18e substantially separates the sheet of material 10e into a first portion 20e and a second portion 22e wherein the first bend 18e forms a first angle 24e between the first portion 20e and the second portion 22e. The first portion 20e has a first decorative feature 26e upon at least a portion thereof and the second portion 22e has a second decorative feature (not shown) upon at least a portion thereof. The second bend 40e substantially further separates the sheet of material 10e into a third portion 42e wherein the second bend 40e forms a second angle 44e between the second portion 22e and the third portion 42e. The third portion 42e has a third decorative feature 46e which is different from at least one of the first decorative feature 26e and the second decorative feature. Preferably each of first angle 24e and second angle 40e is less than or equal to 90 degrees, but one may be greater than 90 degrees and the other less than or equal to 90 degrees. Preferably at least a portion of second portion 22e overlaps with at least a portion of first portion 20e and/or third portion 42e. Any of said overlapping portions may be connected or attached to an adjacent portion of the sheet of material 10e via a connecting material or means such as an adhesive or cohesive bonding material. When the sheet of material 10e is formed about an item such as a potted plant 32, the sheet of material 10e is formed into a decorative cover (not shown, but similar to the decorative cover 48d shown in FIG. 14) which extends about at least a portion of the item, and which is preferably secured thereabout by a securing element 38, and has an appearance of being made from at least two separate sheets of material. The sheet of material 10e is essentially the same as sheet of material 10d except the bends 18e and 40e are reversed in comparison to bends 18d and 40d of sheet of material 10d.

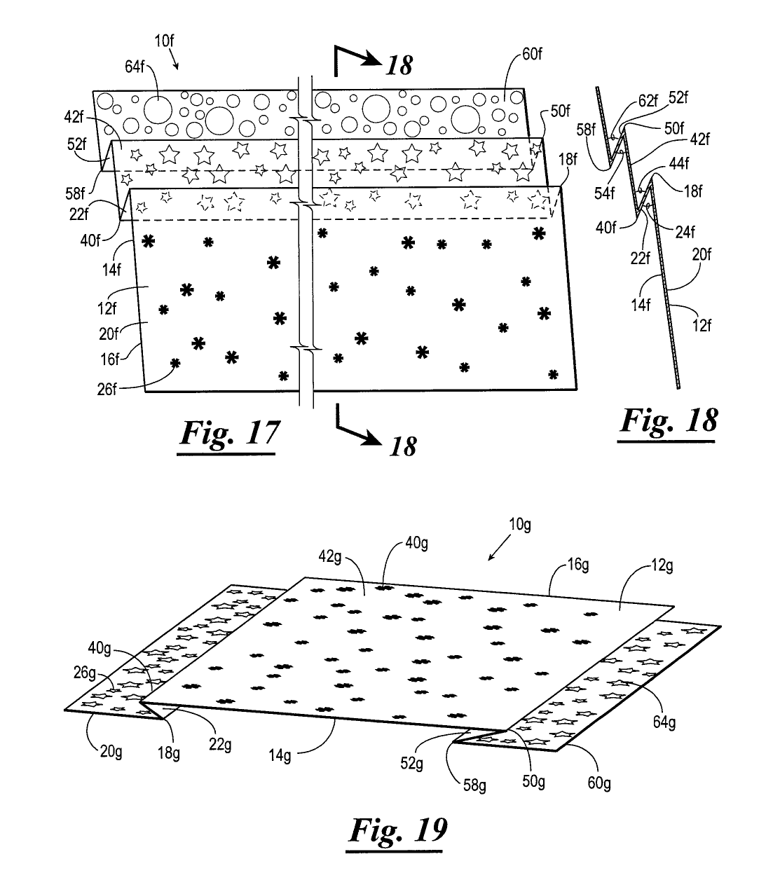

Shown in FIGS. 17-18 and designated therein by reference numeral 10f is another embodiment of the present invention comprising a sheet of material essentially similar to sheet of material 10 except as described below and having a first surface 12f, a second surface 14f, and an outer peripheral edge 16f.

Sheet of material 10f has a first bend 18f and a second bend 40f each of which forms an angular change in the sheet of material 10f extending across at least a portion of the sheet of material 10f. The first bend 18f substantially separates the sheet of material 10f into a first portion 20f and a second portion 22f wherein the first bend 18f forms a first angle 24f between the first portion 20f and the second portion 22f. The first portion 20f has a first decorative feature 26f upon at least a portion thereof and the second portion 22f preferably has a second decorative feature (not shown) upon at least a portion thereof. The second bend 40f substantially further separates the sheet of material 10f into a third portion 42f wherein the second bend 40f forms a second angle 44f between the second portion 22f and the third portion 42f.

Further, sheet of material 10f has a third bend 50f and a fourth bend 58f each of which forms an angular change in the sheet of material 10f extending across at least a portion of the sheet of material 10f. The third bend 50f substantially separates the sheet of material 10f into a fourth portion 52f and the fourth bend 58f substantially separates the sheet of material 10f into a fifth portion 60f. The third bend 50f forms a third angle 54f between the third portion 42f and the fourth portion 52f. The fourth bend 58f forms a fourth angle 62f between the fourth portion 52f and the fifth portion 60f. The fourth portion 52f preferably has a fourth decorative feature (not shown) upon at least a portion thereof and the fifth portion 60f has a fifth decorative feature 64f upon at least a portion thereof.

At least one of the first through fifth decorative features (when present) is different from at least one other of the first through fifth decorative features. Preferably each of first angle 24f, second angle 40f, third angle 54f and fourth angle 62f is less than or equal to 90 degrees, but one or more may be greater than 90 degrees and the others less than or equal to 90 degrees. Preferably at least one of first portion 20f, second portion 22f, third portion 42f, fourth portion 52f, and fifth portion 60f overlaps with at least one of first portion 20f, second portion 22f, third portion 42f, fourth portion 52f, and fifth portion 60f. Any of said overlapping portions may be connected or attached to an adjacent portion of the sheet of material 10f via a connecting material or means such as an adhesive or cohesive bonding material. When the sheet of material 10f is formed about an item such as a potted plant 32, the sheet of material 10f is formed into a decorative cover (not shown, but similar to the decorative cover 48d shown in FIG. 14) which extends about at least a portion of the item, and which is preferably secured thereabout by a securing element 38, and has an appearance of being made from at least two or more separate sheets of material.

Shown in FIG. 19 and designated therein by reference numeral 10g is another embodiment of the present invention comprising a sheet of material essentially similar to sheet of material 10d or other sheets described herein except as described below and having a first surface 12g, a second surface 14g, and an outer peripheral edge 16g.

Sheet of material 10g has a first bend 18g and a second bend 40g each of which forms an angular change in the sheet of material 10g extending across at least a portion of the sheet of material 10g. The first bend 18g substantially separates the sheet of material log into a first portion 20g and a second portion 22g wherein the first bend 18g forms a first angle (not shown) between the first portion 20g and the second portion 22g. The first portion 20g has a first decorative feature 26g upon at least a portion thereof and the second portion 22g optionally has a second decorative feature (not shown) upon at least a portion thereof. The second bend 40g substantially further separates the sheet of material 10g into a centrally positioned third portion 42g wherein the second bend 40g forms a second angle (not shown) between the second portion 22g and the third portion 42g. The third portion 42g has a third decorative feature 46g thereon.

Further, on the end of the sheet of material 10g opposite the first bend 18g and the second bend 40g, the sheet of material log has a third bend 50g and a fourth bend 58g each of which forms an angular change in the sheet of material 10g extending across at least a portion of the sheet of material 10g and which essentially comprise a mirror image of first bend 18g and second bend 40g. The third bend 50g substantially separates the sheet of material 10g into a fourth portion 52g and the fourth bend 58g substantially separates the sheet of material 10g into a fifth portion 60g. The third bend 50g forms a third angle (not shown) between the third portion 42g and the fourth portion 52g. The fourth bend 58g forms a fourth angle (not shown) between the fourth portion 52g and the fifth portion 60g. The fourth portion 52g preferably has a fourth decorative feature (not shown) upon at least a portion thereof and the fifth portion 60g has a fifth decorative feature 64g upon at least a portion thereof.

At least one of the first through fifth decorative features is different from at least one other first through fifth decorative feature. In a preferred embodiment the decorative feature 46g is different from decorative features 26g and 64g, or different from at least one of decorative features 26g and 64g. Alternatively, the first through fifth decorative features are all the same or similar.

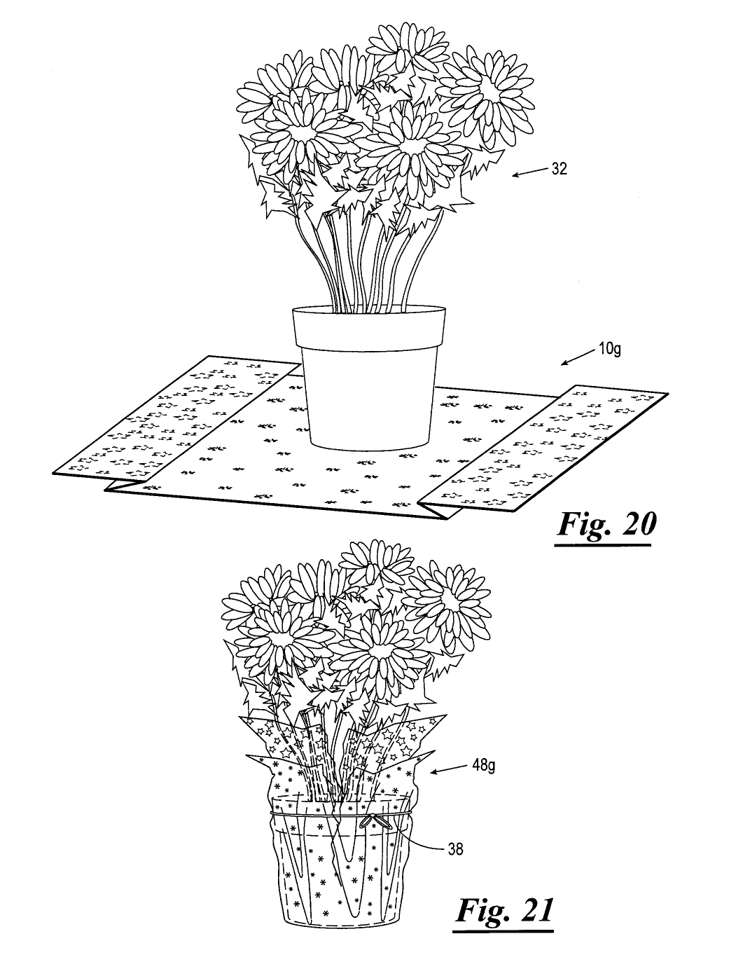

Preferably each of the first angle, second angle, third angle and fourth angle is less than or equal to 90 degrees, but one or more may be greater than 90 degrees and the others less than or equal to 90 degrees. Preferably at least one of first portion 20g, second portion 22g, third portion 42g, fourth portion 52g, and fifth portion 60g overlaps with at least one of first portion 20g, second portion 22g, third portion 42g, fourth portion 52g, and fifth portion 60g. Any of said overlapping portions may be connected or attached to an adjacent portion of the sheet of material 10g via a connecting material or means such as an adhesive or cohesive bonding material. When the sheet of material log is formed about an item such as a potted plant 32, the sheet of material 10g is formed into a decorative cover 48g (FIGS. 20-21) which extends about at least a portion of the item, and which is preferably secured thereabout by a securing element 38, and has an appearance of being made from at least two or more separate sheets of material. The sheet 10g like other sheets described herein may have one or more holes in a portion thereof for forming one or more drainage holes when the sheet 10g is formed into the decorative cover 48g.

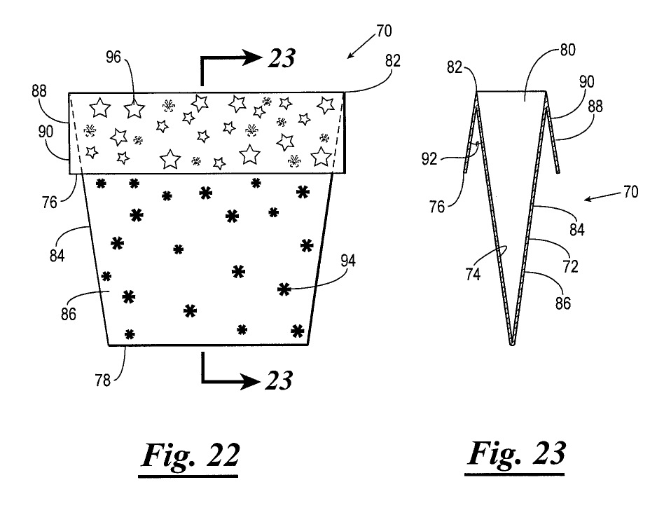

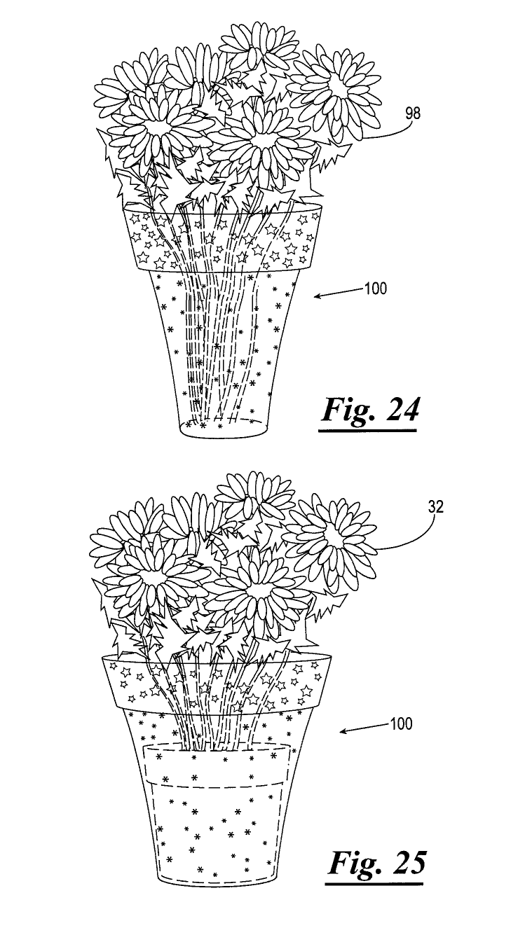

Shown in FIGS. 22 and 23 is an alternate embodiment of the invention comprising a floral sleeve and designated by the general reference numeral 70. The sleeve 70 has an outer surface 72, an inner surface 74, a peripheral edge 76, a lower end 78, and an inner retaining space 80. The sleeve 70 has a bend 82 which forms an angular change in the sleeve 70 and preferably is in an upper portion of the sleeve 70 which separates the sleeve 70 into a first portion 84, which constitutes a body 86 of the sleeve 70, and a second portion 88, which constitutes a skirt 90 of the sleeve 70. There is an angle 92 in the bend 82 between the body 86 and the skirt 90. The angle 92 may be less than, equal to, or greater than 90 degrees. The body 86 has a first decorative feature 94 which is different from a second decorative feature 96 of the skirt 90. The sleeve 70 is constructed of the same materials used to construct the sheets of material described elsewhere herein and has the same characteristics as said sheets. When the sleeve 70 is disposed about a floral bouquet 98 or potted plant 32 it forms a decorative cover 100 (FIGS. 24 and 25) which has an appearance of being formed from at least two separate sheets due to the differences between the first decorative feature 94 and the second decorative feature 96, as discussed previously herein. Preferably each of the floral sleeves described herein is initially constructed in a substantially flattened state and is openable therefrom to an opened state for receiving an item. The lower end 78 may be completely closed, partially closed or open, or may have holes therein for drainage.

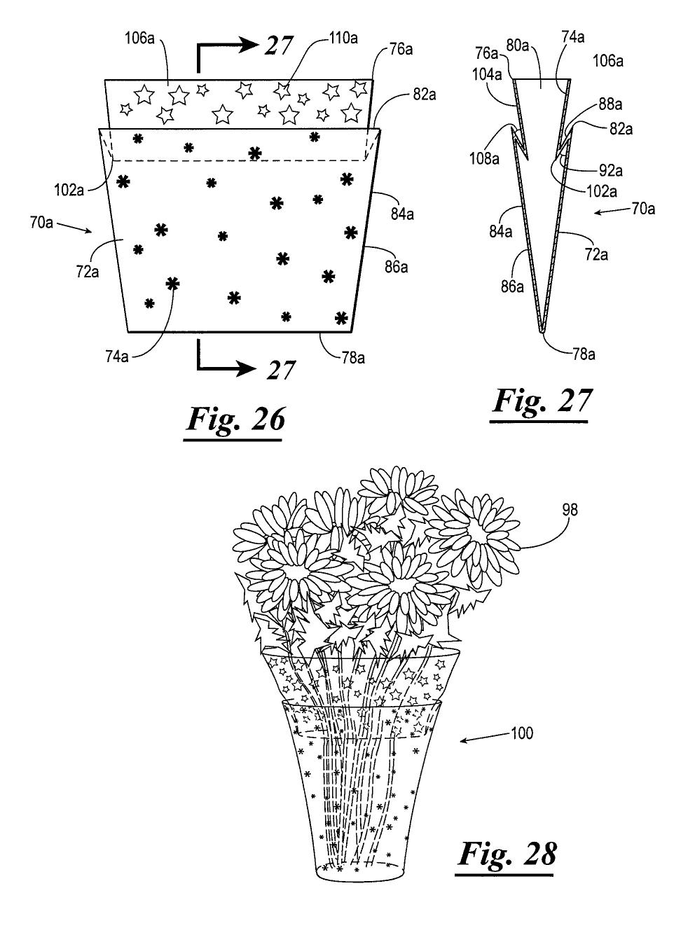

Shown in FIGS. 26 and 27 is another floral sleeve of the present invention designated by the general reference numeral 70a. Sleeve 70a has an outer surface 72a, an inner surface 74, a peripheral edge 76a, a lower end 78a, and an inner retaining space 80a. The sleeve 70a is similar to sleeve 70 except as described herein.

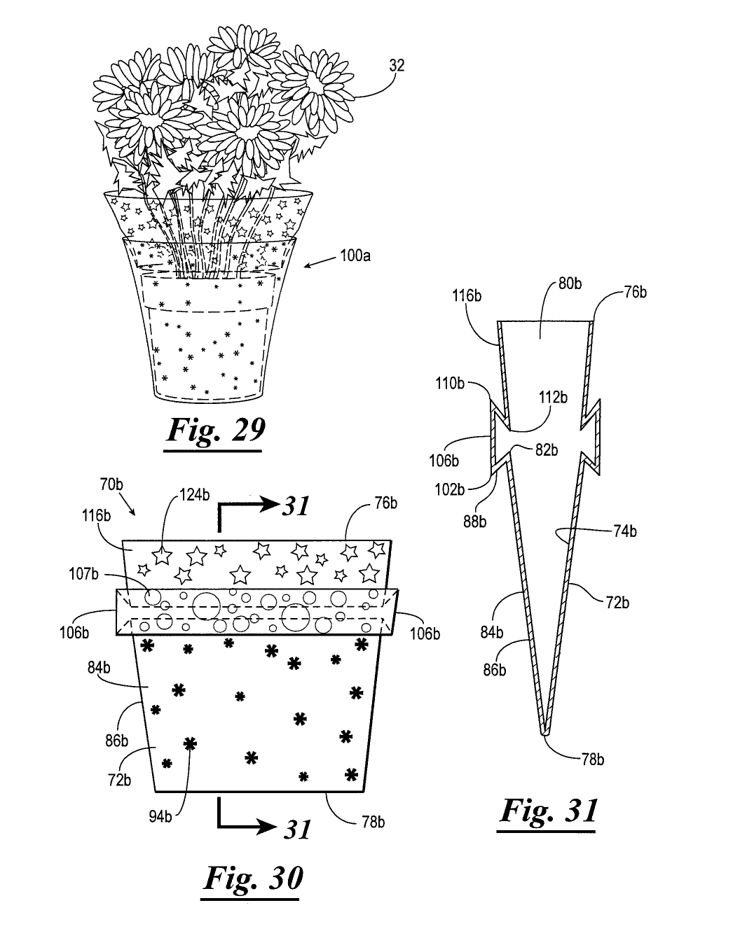

Sleeve 70a has a first bend 82a and a second bend 102a each of which forms an angular change in the sleeve 70a extending across at least a portion of the sleeve 70a. The first bend 82a substantially separates the sleeve 70a into a first portion 84a which constitutes a body 86a, a second portion 88a and a third portion 104a. The first bend 82a forms a first angle 92a between the first portion 84a and the second portion 88a. The first portion 84a has a first decorative feature 94a upon at least a portion thereof and the second portion 88a optionally has a second decorative feature (not shown) upon at least a portion thereof. The second bend 102a substantially further separates the sleeve 70a into a third portion 106a wherein the second bend 102a forms a second angle 108a between the second portion 88a and the third portion 106a. The third portion 106a has a third decorative feature 110a which is different from at least one of the first decorative feature 94a and the second decorative feature (not shown). Preferably each of first angle 92a and second angle 108a is less than 90 degrees, but one may be greater than 90 degrees and the other less than 90 degrees, or both may be greater than 90 degrees. When the sleeve 70a is formed about an item such as a floral bouquet 98 or a potted plant 32, the sleeve 70a is formed into a decorative cover 100a (see FIGS. 28 and 29) which extends about at least a portion of the item and has an appearance of being made from at least two separate sheets of material. Optionally, the decorative cover 100 or 100a is secured thereabout by a securing element (not shown).

Shown in FIGS. 30 and 31 and designated therein by reference numeral 70b is another floral sleeve embodiment of the present invention comprising a sleeve which is essentially similar to sleeve 70 or 70a except as described below. Sleeve 70b has an outer surface 72b, an inner surface 74b, a peripheral edge 76b, a lower end 78b and an inner retaining space 80b.

Sleeve 70b has a first bend 82b and a second bend 102b each of which forms an angular change in the sleeve 70b extending across at least a portion of the sleeve 70b. The first bend 82b substantially separates the sleeve 70b into a first portion 84b which constitutes a body 86b, a second portion 88b wherein the first bend 82b forms a first angle 92b between the first portion 84b and the second portion 88b. The first portion 84b has a first decorative feature 94b upon at least a portion thereof and the second portion 88b preferably optionally has a second decorative feature (not shown) upon at least a portion thereof. The second bend 102b substantially further separates the sleeve 70b into an intermediately-positioned third portion 106b wherein the second bend 102b forms a second angle 108b between the second portion 88b and the third portion 106b. The third portion 106b has a third decorative feature 107b thereon.

Above the first bend 82b and the second bend 102b on the sleeve 70b, the sleeve 70b has a third bend 110b and a fourth bend 112b each of which forms an angular change in the sleeve 70b extending across at least a portion of the sleeve 70b and which essentially comprise a mirror image of first bend 82b and second bend 102b. The third bend 110b substantially separates the sleeve 70b into a fourth portion 114b and the fourth bend 112b substantially separates the sleeve 70b into a fifth portion 116b. The third bend 110b forms a third angle 118b between the third portion 106b and the fourth portion 114b. The fourth bend 112b forms a fourth angle 120b between the fourth portion 114b and the fifth portion 116b. The fourth portion 114b preferably has a fourth decorative feature (not shown) upon at least a portion thereof and the fifth portion 116b has a fifth decorative feature 124b upon at least a portion thereof.

At least one of the first through fifth decorative features is different from at least one other of the first through fifth decorative features. In a preferred embodiment the decorative feature 107b is different from one of decorative features 94b and 124b, or from both decorative features 94b and 124b, wherein decorative features 94b and 124b may be the same or similar, or different.

Preferably each of first angle 92b, second angle 108b, third angle 118b and fourth angle 120b is less than 90 degrees, but one or more may be equal to or greater than 90 degrees and the others less than 90 degrees. Preferably at least one of first portion 84b, second portion 88b, third portion 106b, fourth portion 114b, and fifth portion 116b overlaps with at least one other portion of the sleeve 70b. Any of said overlapping portions may be connected or attached to an adjacent portion of the sleeve 70b via a connecting material or means such as an adhesive or cohesive bonding material. When the sleeve 70b is formed about an item such as a potted plant (not shown), the sleeve 70b is formed into a decorative cover (not shown) which extends about at least a portion of the item and has an appearance of being made from at least two or more separate sheets of material, and which is preferably secured thereabout by a securing element as described above.

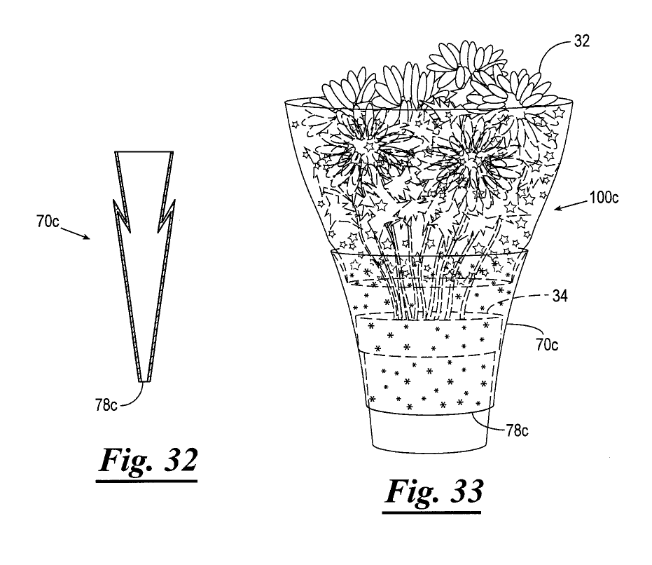

Shown in FIG. 32 is a sleeve 70c which is exactly the same as sleeve 70a except sleeve 70c has an open lower end 78c. When the sleeve 70c is applied about a potted plant 32 it is formed into a decorative cover 100c having the open lower end 78c through which a portion of the pot 34 of the potted plant 32 is visible (see FIG. 33). Such a sleeve 70c is sometimes referred to in the art as a “sleeve collar” because it may be used both as a sleeve to protect the potted plant 32 but may also be used as a collar, or securing element, to hold another decorative device, such as a decorative sheet or sleeve, upon the potted plant or about a floral grouping.

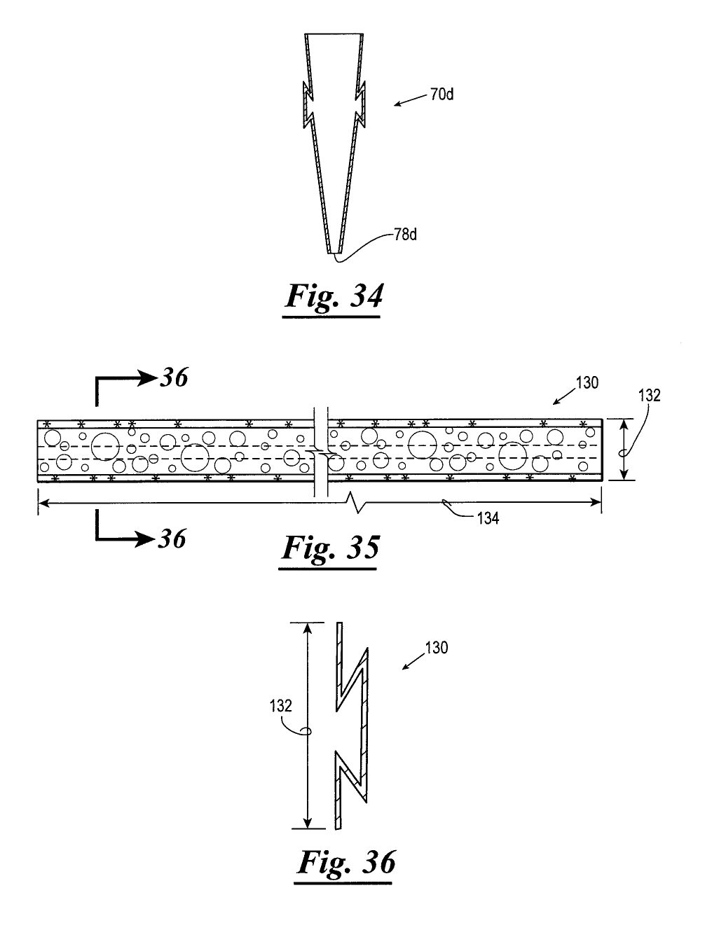

Similarly, shown in FIG. 34 is a sleeve 70d which is exactly the same as sleeve 70b except it has an open lower end 78d.

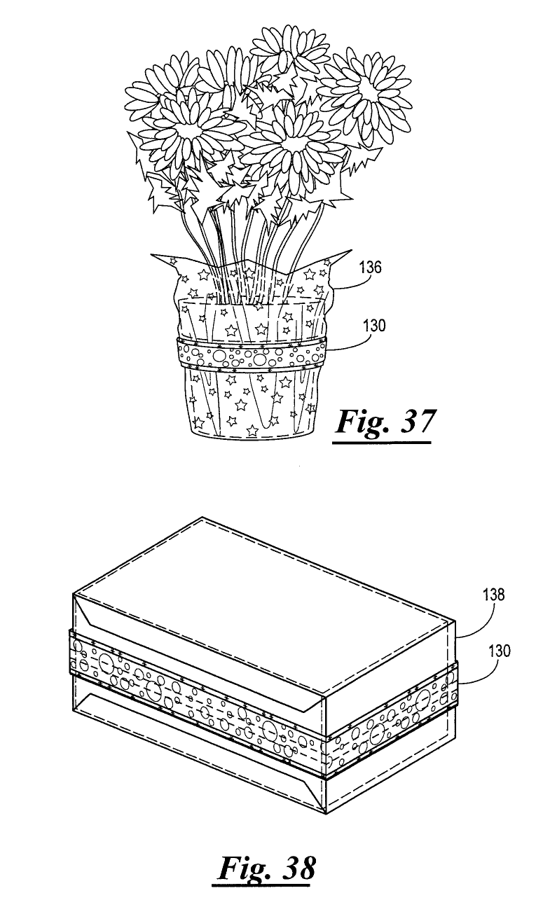

Shown in FIGS. 35 and 36 is an embodiment of the invention comprising a ribbon or strip designated by the general reference numeral 130. The ribbon 130 has a decorative motif and configuration similar to that of the sheet of material 10d in FIG. 19 except the ribbon 130 has a width 132 which is substantially less than a length 134 of the ribbon 130. The ribbon 130 can be applied as a decoration or securing element about an item such as a wrapped potted plant 136 (FIG. 37) or about a wrapped box or package 138 (FIG. 38), for example and provides a ribbon or strip which appears to be made from at least two separate ribbons or strips.

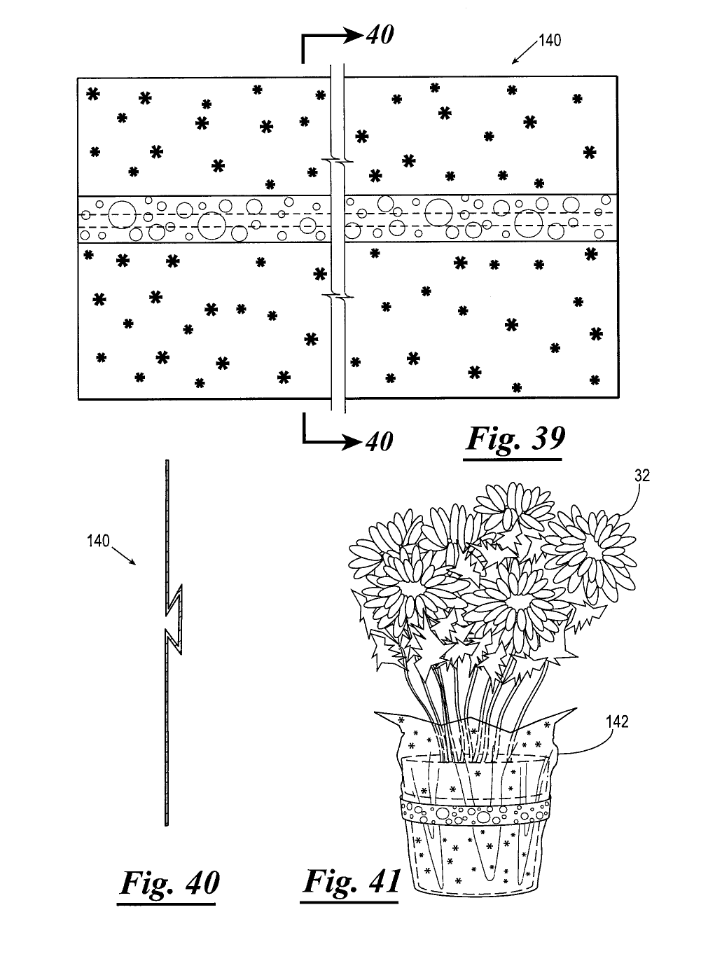

Shown in FIGS. 39 and 40 is a sheet of material 140 which is constructed in a manner similar to that of ribbon 130 of FIGS. 35 and 36 except the sheet of material 140 is much wider than the ribbon 130 and as such can be used as a decorative wrapper 142 about a potted plant 32 (or other item) such as shown in FIG. 41. The decorative wrapper 142 thus has the appearance of having a separate “ribbon” disposed thereabout.

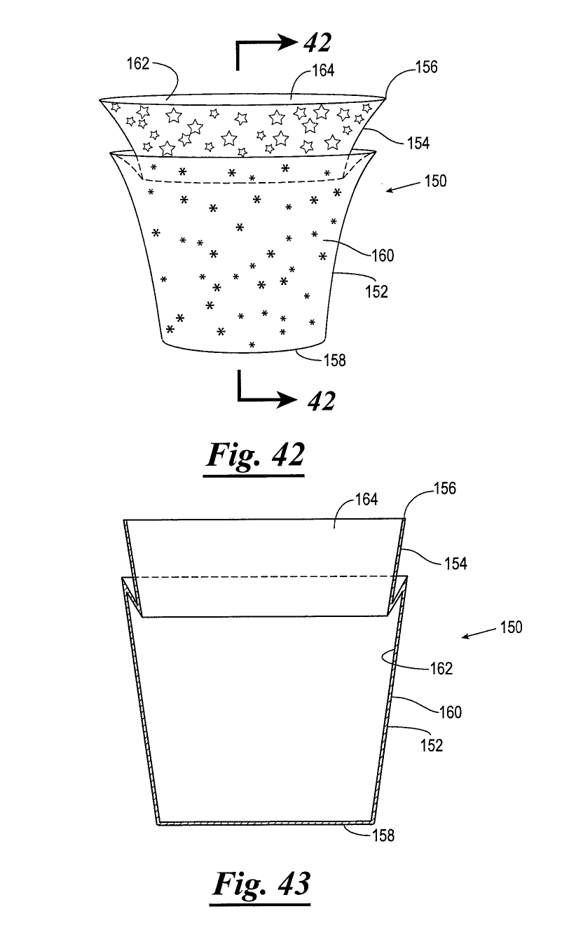

Shown in FIGS. 42 and 43 and designated therein by the general reference numeral 150 is a preformed cover having a generally frusto-conical shape and having a first sidewall 152, a second sidewall 154, an upper end 156, a lower end 158, an outer surface 160, and inner surface 162 and an inner retaining space 164. The preformed cover 150 is constructed of the same materials used to construct the sheets, sleeves and ribbons discussed elsewhere herein.

The cover 150 has a first bend 166 and a second bend 168 each of which forms an angular change in the pot cover 150. The first bend 166 and second bend 168 substantially separate the cover 150 into the first sidewall 152 and the second sidewall 154. The first sidewall 152 has a first decorative feature 170 upon at least a portion thereof and the second sidewall 154 has a second decorative feature 172 upon at least a portion thereof. Between the first sidewall 152 and the second sidewall 154 is an intermediate portion 174 therebetween which may have a decorative feature (not shown) which is different or similar to the first decorative feature 170 and/or the second decorative feature 172. Preferably each of the angles between the first sidewall 152 and second sidewall 154 is less than 90 degrees, but one may be greater than 90 degrees and the other less than or equal to 90 degrees or both may be greater than 90 degrees. Preferably at least a portion of the second sidewall 154 overlaps with at least a portion of the first sidewall 152. Any of said overlapping portions may be connected or attached to an adjacent portion of the cover 50 via a connecting material or means such as an adhesive or cohesive bonding material. When the cover 150 is placed about an item such as a potted plant or floral grouping (not shown), the cover 150 has an appearance of being formed from at least two separate sheets or two separate covers. Other embodiments of the cover may have more than two bends thereby forming covers having more than two sidewalls. The lower end 158 may be completely closed, partially closed, or open and may have one or more drainage holes therein. The cover 150 may be used to contain a plant and growing or retaining medium without a pot or pot-like device.

Changes may be made in the construction and the operation of the various components, elements and assemblies described herein or in the steps or the sequence of steps of the methods described herein without departing from the spirit and scope of the invention as defined in the following claims.

What is claimed is:

1. A decorative wrapper, comprising:
at least one sheet of material having a first surface, a second surface, and an outer peripheral edge and the sheet of material having at least two bends extending across at least a portion of the sheet of material and wherein a first bend substantially separates the sheet of material into at least a first portion and at least a second portion, the first bend forming an angle in the sheet of material between the first portion and the second portion, and a second bend extending across at least a portion of the surface of the sheet of material;
wherein the first portion has a first decorative feature and the second portion has a second decorative feature which is at least partially different from the first decorative feature such that when the at least one sheet of material is formed about an item, the at least one sheet of material forms a decorative cover about the item, the decorative cover having an appearance of being made from at least two separate sheets; and,
wherein the first decorative feature and second decorative feature is at least one of a color, decoration, design, texture, pattern, characteristic, or appearance.
